(19) United States
(12) Patent Application Publication
(10) Pub. No.: US 2024/0128564 A1
(43) Pub. Date: Apr. 18, 2024

(54) CHASSIS CONFIGURED FOR USE WITH PRISMATIC BATTERY CELLS

(71) Applicant: Enphase Energy, Inc., Petaluma, CA (US)

(72) Inventors: Christopher McNair LYKE, Austin, TX (US); David Garrett Stanton, Austin, TX (US); Wei Jiang, Round Rock, TX (US)

(21) Appl. No.: 18/377,346

(22) Filed: Oct. 6, 2023

Related U.S. Application Data
(60) Provisional application No. 63/415,336, filed on Oct. 12, 2022.

(51) Int. Cl. H01M 50/209; H01M 10/04; H01M 50/224; H01M 50/251; H01M 50/264; H01M 50/291; H01M 50/293; H01M 50/691

(52) U.S. Cl. CPC H01M 50/209; H01M 10/0481; H01M 50/224; H01M 50/251; H01M 50/264; H01M 50/291; H01M 50/293; H01M 50/691; H01M 2220/10

(57) ABSTRACT

The present disclosure provides a chassis configured for use an energy storage system. The chassis comprises a housing configured to support a plurality of battery cells, a first sidewall pad and a top wall pad configured to cushion the plurality of battery cells when supported within the housing, a compression wedge configured to fit between the plurality of battery cells and a second sidewall of the chassis to apply a compressive load on the plurality of battery cells, and a retention bracket configured to connect to a first sidewall of the chassis and the second sidewall to maintain the plurality of battery cells against a rear wall of the chassis.

### CROSS-REFERENCE TO RELATED APPLICATIONS

The present application claims the benefit of and priority to U.S. Provisional Application Ser. No. 63/415,336, filed on Oct. 12, 2022, the entire contents of which is incorporated herein by reference.

### BACKGROUND

### Field of the Disclosure

Embodiments of the present disclosure relate generally to energy storage systems, and, for example, to chassis configured for use with prismatic battery cells.

### Description of the Related Art

Conventional energy storage systems (battery systems) can comprise one or more cells that connect to one or more PCBA (printed circuit boards assemblies) via one or more terminal connectors. For example, cylindrical cell configurations can be electrically connected to the PCBA using spot or wedge welding on metal bus bars or by using bolts to connect cells with threaded tabs. As such an approach mostly requires automatic welding lines, field replacement of problematic cells to avoid unnecessary RMA of an entire battery module is not possible or can be extremely difficult to conduct (e.g., each screw must be removed layer by layer).

Metal housings for prismatic battery cells that are configured for use with energy storage systems (energy management systems, electric battery modules, etc.) are known. Most of the metal housings are built from multiple components that are, typically, welded or bolted together, which requires the metal housing to be fully disassembled to replace one or more bad battery cells.

Accordingly, there is a need for improved chassis configured for use with prismatic battery cells.

### SUMMARY

In accordance with some aspects of the disclosure, a chassis configured for use as an energy storage system comprises a housing configured to support a plurality of battery cells, a first sidewall pad and a top wall pad configured to cushion the plurality of battery cells when supported within the housing, a compression wedge configured to fit between the plurality of battery cells and a second sidewall of the chassis to apply a compressive load on the plurality of battery cells, and a retention bracket configured to connect to a first sidewall of the chassis and the second sidewall to maintain the plurality of battery cells against a rear wall of the chassis.

In accordance with some aspects of the disclosure, an energy management system comprises a distributed energy resource comprising a renewable energy source, a load center connected to the renewable energy source, and an energy storage system comprising a chassis comprising a housing configured to support a plurality of battery cells, a first sidewall pad and a top wall pad configured to cushion the plurality of battery cells when supported within the housing, a compression wedge configured to fit between the plurality of battery cells and a second sidewall of the chassis to apply a compressive load on the plurality of battery cells, and a retention bracket configured to connect to a first sidewall of the chassis and the second sidewall to maintain the plurality of battery cells against a rear wall of the chassis.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure; and

FIGS. 2A-2E are diagrams of a chassis configured for use with a prismatic battery cell electrical configuration, in accordance with one or more embodiments of the present disclosure.

### DETAILED DESCRIPTION

Embodiments of the present disclosure relate to chassis configured for use with prismatic battery cells. For example, a chassis configured for use an energy storage system comprises a housing, a first sidewall pad and a top wall pad configured to cushion a plurality of battery cells when supported within the housing, an optional removable tray configured to maintain the plurality of battery cells in a relatively upright configuration, a compression wedge configured to fit between the plurality of battery cells and a second sidewall pad of the chassis different from the first sidewall pad to apply a compressive load on the plurality of battery cells, and a retention bracket configured to maintain the plurality of battery cells against a rear wall of the chassis. The apparatus described herein provide a prismatic battery cell design that enables a cell-to-system assembly and connection of prismatic battery cell to be completed in one process without the use of additional bolts, clamps, and bus bars for connecting the prismatic battery cell. Additionally, the apparatus described herein provide relatively easy field replacement of prismatic battery cells, thus alleviating the need for total module RMA and provides potential commercial advantages to sale.

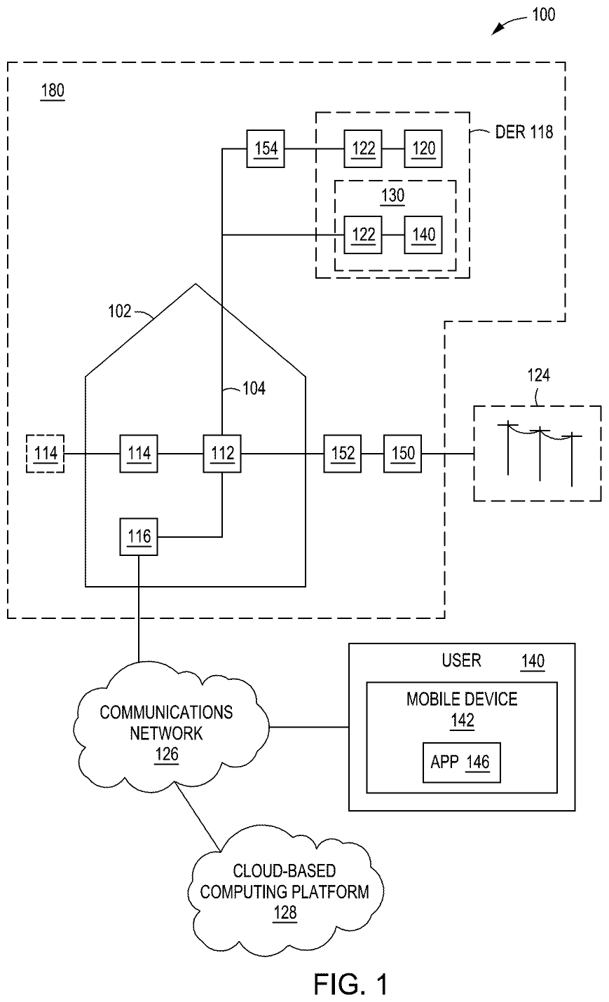

FIG. 1 is a block diagram of a system 100 (e.g., an energy management system or power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads (e.g., appliances, electric hot water heaters, thermostats/detectors, boilers, water pumps, and the like), one or more energy storage devices (an energy storage system 114), which can be located within or outside the structure 102, and a DER controller 116, each coupled to a load center 112. Although the energy storage system 114, the DER controller 116, and the load center 112 are depicted as being located within the structure 102, one or more of these may be located external to the structure 102. In at least some embodiments, the energy storage system 114 can be, for example, one or more of the energy storage devices (e.g., IQ Battery 10®) commercially available from Enphase® Inc. of Petaluma, CA. Other energy storage devices from Enphase® Inc. or other manufacturers may also benefit from the inventive methods and apparatus disclosed herein.

The load center 112 is coupled to the DER 118 by an AC bus 104 and is further coupled, via a meter 152 and a MID 150 (e.g., microgrid interconnect device), to a grid 124 (e.g., a commercial/utility power grid). The structure 102, the energy storage system 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a battery 141 may be referred to as an AC battery 130.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads and/or the energy storage system 114. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications 146 (e.g., a grid connectivity control application) installed thereon for controlling the connectivity with the grid 124 as described herein. The one or more applications 146 may run on commercially available operating systems, such as 10S, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

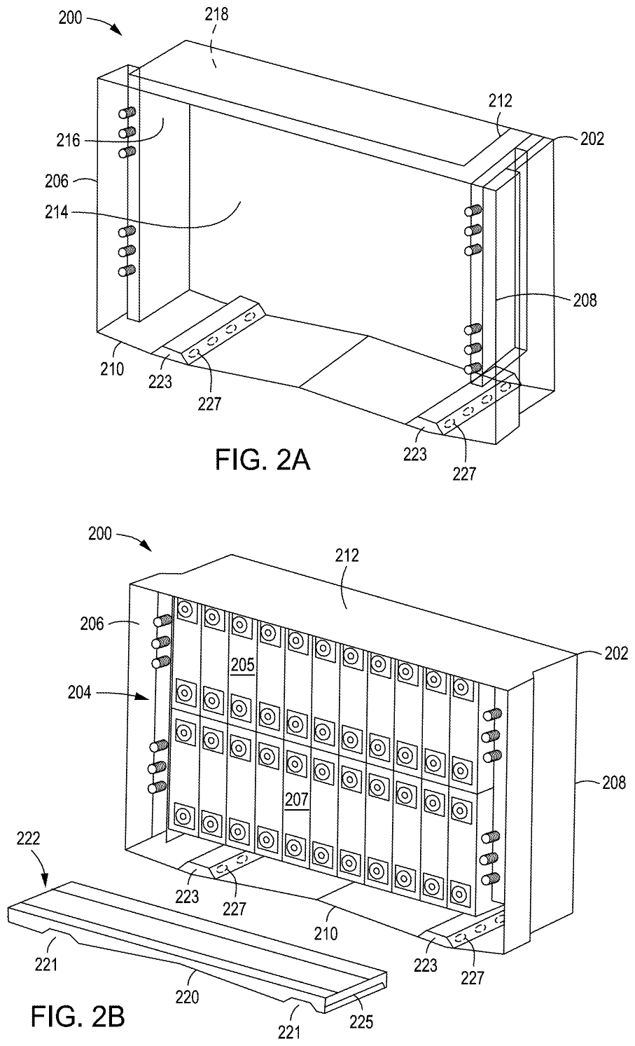

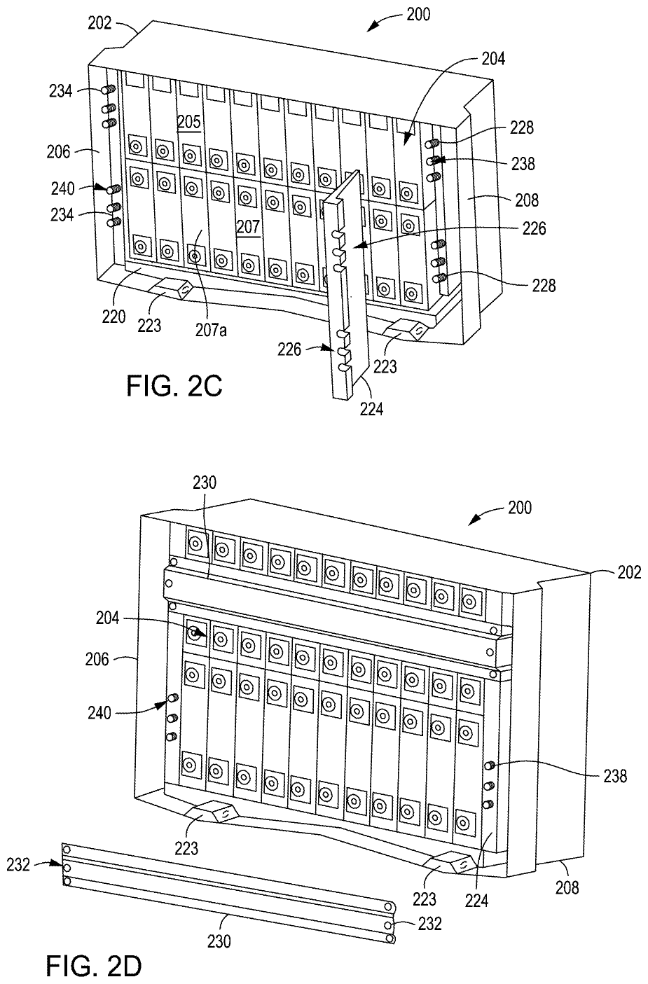

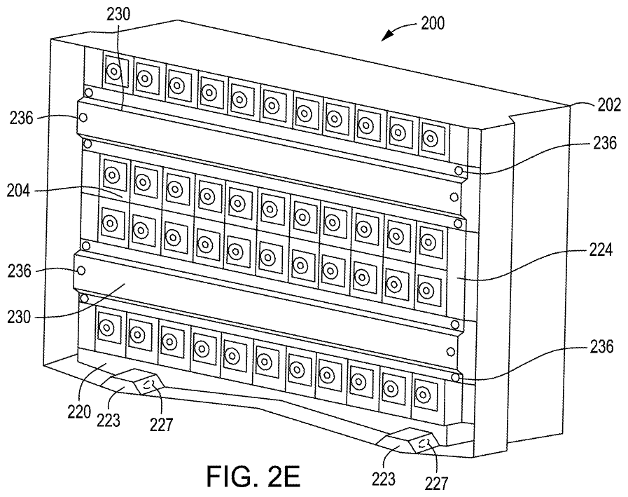

FIGS. 2A-2E are diagrams of a chassis 200 configured for use with a prismatic battery cell electrical configuration (e.g., configured for use with the energy storage system 114), in accordance with one or more embodiments of the present disclosure.

The inventors have found that a chassis made from a single die cast metal part provides structural support and compression for a plurality of battery cells while also allowing for relatively easy battery cell removal and/or replacement (e.g., field swappable). For example, the plurality of battery cells can be secured in the chassis 200 and removed from the chassis 200 all in one direction, making assembly/disassembly easier when compared to conventional chassis. Additionally, the inventive chassis configuration described herein, enable the plurality of battery cells to be in relatively close contact with the chassis walls, thus reducing volumetric energy density and providing thermal advantages.

Continuing with reference to FIGS. 2A-2E, the chassis 200 (FIG. 2A) is die cast chassis made from one or more suitable metals including, but not limited to zinc, copper, aluminum, magnesium, lead, pewter, or tin-based alloys. In at least some embodiments, the chassis 200 is made from aluminum. The chassis 200 comprises a housing 202 configured to support a plurality of battery cells, e.g., a plurality of battery cells 204. For example, the plurality of battery cells 204 can comprise two rows (e.g., eleven cells) of upper prismatic battery cells 205 that can be stacked on top two rows (e.g., eleven cells) of lower prismatic battery cells 207 (FIG. 2B). The chassis 200 can, however, can be configured to accommodate a number of other prismatic battery cell shapes and/or orientations.

The chassis 200 comprises a first sidewall 206, a second sidewall 208, a bottom wall 210, a top wall 212, a rear wall 214. A first sidewall pad 216 is attached to the first sidewall 206 and a top wall pad 218 is attached to the top wall 212. The first sidewall pad 216 and the top wall pad 218 can be attached to the first sidewall 206 and top wall 212 via one or more of adhesives, bolts, screws or other suitable attachment devices. In at least some embodiments, adhesive is used to attach the first sidewall pad 216 and the top wall pad 218 the first sidewall 206 and the top wall 212, respectively. The first sidewall pad 216 and the top wall pad 218 can be made from one or more materials that are capable of applying a compressive force to the plurality of prismatic battery cells. In at least some embodiments, the first sidewall pad 216 and the top wall pad 218 can be made from foam. The first sidewall pad 216 and the top wall pad 218 are configured to cushion the plurality of battery cells when the plurality of battery cells supported within the housing. The first sidewall pad 216 and the top wall pad 218 are also configured to conform with a draft angle of the chassis' walls (see FIG. 2A). In at least some embodiments, a thermal interface material can be applied to the rear wall 214 of the chassis.

A removable tray 220 (e.g., made from plastic) can be disposed on the bottom wall 210 and can be configured to maintain the plurality of battery cells 204 in a relatively upright configuration above the bottom wall 210 when the plurality of battery cells 204 are supported within the housing 202 (FIG. 2B). While the removable tray 220 facilitates retaining the plurality of battery cells 204 in the relatively upright configuration, the removable tray 220 does not provide much compressive force on the plurality of battery cells 204. One or more grooves 222 can be disposed on a top surface of the removable tray 220 and can be configured to collect fluid in the housing 202, e.g., condensation, electrolyte that leaks from the plurality of battery cells 204, etc. For example, the removable tray 220 can be removed from the housing 202 to dispose of collected electrolyte.

Additionally, a bottom surface of the removable tray 220 can comprise one or more ribs 225 that allows fluid (e.g., condensation) in the housing 202 to drain through holes (e.g., weep holes 227) defined in the bottom wall 210. For example, the one or more ribs 225 allow condensation that forms on the walls of the chassis 200 to travel down to the chassis' weep holes 227. Moreover, the bottom surface of the removable tray 220 can comprise one or more elongated grooves configured to engage one or more corresponding elongated rails disposed on an upper surface of the bottom wall 210. For example, in at least some embodiments, two elongated grooves 221 can be defined on a bottom surface of the removable tray 220 and can be configured to engage the two elongated rails 223 disposed on the top surface of the bottom wall 210. When engaged, the two elongated grooves 221 and the two elongated rails 223 prevent lateral movement (side-to-side) of the plurality of battery cells 204.

A compression wedge 224 (e.g., made from plastic) can be configured to fit between the plurality of battery cells 204 and the second sidewall 208 of the chassis 200 to apply a compressive load on the plurality of battery cells 204 (FIG. 2C). For example, the compression wedge 224 can be slid between the plurality of battery cells 204 and the second sidewall 208. In use, the compression wedge 224 applies a compressive load on the plurality of battery cells 204 and converts a drafted chassis wall to a relatively flat surface, e.g., in a manner similar to the first sidewall pad.

Additionally, the compression wedge 224 comprises one or more notches 226 that are configured to engage one or more corresponding protrusions 228 disposed on the second sidewall 208 of the chassis 200 for coupling a retention bracket 230 to the chassis 200 (FIG. 2D). For example, the retention bracket 230 is configured to connect to the first sidewall 206 and the second sidewall 208 to maintain the plurality of battery cells 204 against the rear wall 214 of the chassis 200. For example, the retention bracket 230 comprises one or more apertures 232 that align with the one or more notches 226, the one or more corresponding protrusions 228 disposed on the second sidewall, and one or more corresponding protrusions 234 disposed on the first sidewall 206. To secure the plurality of battery cells 204 against the rear wall 214 of the chassis 200, the apertures 232 on the retention bracket 230 are configured to receive a bolt 236 that engages a threaded aperture 238 defined in the one or more corresponding protrusions 228 disposed on the second sidewall 208 and a threaded aperture 240 defined in the one or more corresponding protrusions 234 disposed on the first sidewall 206 (FIGS. 2C-2E).

In use, when one or more bad battery cells need to be replaced (FIG. 2E), a user can unbolt the retention brackets 230 (FIG. 2D). Next, the user can remove retention brackets 230 to access the one or more bad battery cells. Next, the user can remove the compression wedge 224 to remove the compressive force on the plurality of battery cells (e.g., loosen the plurality of battery cells) so that the one or more battery cells, e.g., a battery cell 207a in the lower prismatic battery cells 207, can be removed (pulled out)/replaced (pushed in) (FIG. 2C). In at least some embodiments, a user can remove the removable tray 220 prior to removing/replacing the battery cell 207a, but such an operation is optional, as the removable tray 220 does not impart much compressive force, as described above.

While the foregoing is directed to embodiments of the present disclosure, other and further embodiments of the disclosure may be devised without departing from the basic scope thereof, and the scope thereof is determined by the claims that follow.

What is claimed is:

1. A chassis configured for use an energy storage system, comprising:
a housing configured to support a plurality of battery cells;
a first sidewall pad and a top wall pad configured to cushion the plurality of battery cells when supported within the housing;
a compression wedge configured to fit between the plurality of battery cells and a second sidewall of the chassis to apply a compressive load on the plurality of battery cells; and
a retention bracket configured to connect to a first sidewall of the chassis and the second sidewall to maintain the plurality of battery cells against a rear wall of the chassis.

2. The chassis of claim 1, wherein the first sidewall pad and the top wall pad are made from foam.

3. The chassis of claim 1, wherein the chassis is made from die cast metal.

4. The chassis of claim 1, further comprising a removable tray disposed on a top surface of a bottom wall of the chassis and configured to maintain the plurality of battery cells in a relatively upright configuration above the bottom wall when supported within the housing, wherein the removable tray is made from plastic.

5. The chassis of claim 4, wherein a top surface of the removable tray comprises a plurality of grooves configured to collect fluid in the housing.

6. The chassis of claim 4, wherein a bottom surface of the removable tray comprises a rib that allows fluid in the housing to drain through holes defined in the bottom wall of the chassis, and
wherein the bottom surface comprises two elongated grooves configured to engage two elongated rails disposed on the top surface of the bottom wall, such that when engaged, the two elongated grooves and two elongated rails prevent lateral movement of the plurality of battery cells.

7. The chassis of claim 1, wherein the compression wedge is made from plastic.

8. The chassis of claim 1, wherein the compression wedge comprises a notch configured to engage a corresponding protrusion disposed on the second sidewall of the chassis.

9. The chassis of claim 8, wherein the retention bracket comprises apertures that align with the notch, the corresponding protrusion disposed on the second sidewall, and a corresponding protrusion disposed on the first sidewall, and wherein the apertures on the retention bracket are configured to receive a bolt that engages a threaded aperture defined in the corresponding protrusion disposed on the second sidewall and a threaded aperture defined in the corresponding protrusion disposed on the first sidewall.

10. The chassis of claim 1, wherein the plurality of battery cells are a prismatic battery cell electrical configuration.

11. An energy management system, comprising:
a distributed energy resource comprising a renewable energy source;
a load center connected to the renewable energy source; and
an energy storage system comprising a chassis comprising:
a housing configured to support a plurality of battery cells;
a first sidewall pad and a top wall pad configured to cushion the plurality of battery cells when supported within the housing;
a compression wedge configured to fit between the plurality of battery cells and a second sidewall of the chassis to apply a compressive load on the plurality of battery cells; and
a retention bracket configured to connect to a first sidewall of the chassis and the second sidewall to maintain the plurality of battery cells against a rear wall of the chassis.

12. The energy management system of claim 11, wherein the first sidewall pad and the top wall pad are made from foam.

13. The energy management system of claim 11, wherein the chassis is made from die cast metal.

14. The energy management system of claim 11, further comprising a removable tray disposed on a top surface of a bottom wall of the chassis and configured to maintain the plurality of battery cells in a relatively upright configuration above the bottom wall when supported within the housing,
wherein the removable tray is made from plastic.

15. The energy management system of claim 14, wherein a top surface of the removable tray comprises a plurality of grooves configured to collect fluid in the housing.

16. The energy management system of claim 14, wherein a bottom surface of the removable tray comprises a rib that allows fluid in the housing to drain through holes defined in the bottom wall of the chassis, and
wherein the bottom surface comprises two elongated grooves configured to engage two elongated rails disposed on the top surface of the bottom wall, such that when engaged, the two elongated grooves and two elongated rails prevent lateral movement of the plurality of battery cells.

17. The energy management system of claim 11, wherein the compression wedge is made from plastic.

18. The energy management system of claim 11, wherein the compression wedge comprises a notch configured to engage a corresponding protrusion disposed on the second sidewall of the chassis.

19. The energy management system of claim 18, wherein the retention bracket comprises apertures that align with the notch, the corresponding protrusion disposed on the second sidewall, and a corresponding protrusion disposed on the first sidewall, and wherein the apertures on the retention bracket are configured to receive a bolt that engages a threaded aperture defined in the corresponding protrusion disposed on the second sidewall and a threaded aperture defined in the corresponding protrusion disposed on the first sidewall.

20. The energy management system of claim 11, wherein the plurality of battery cells are a prismatic battery cell electrical configuration.
